(19) United States
(12) Patent Application Publication
(10) Pub. No.: US 2009/0184834 A1
(43) Pub. Date: Jul. 23, 2009

(54) SYSTEM AND METHOD FOR MONITORING STEP MOTOR

(75) Inventors: Ko-Wen Chiu, Hsinchu City (TW); Wen-Yo Lee, Taipei County (TW); Kai-Che Chang, Taipei County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignees: UNITED MICROELECTRONICS CORP., Hsinchu (TW); LUNGHWA UNIVERSITY OF SCIENCE AND TECHNOLOGY, Taoyuan County (TW)

(21) Appl. No.: 12/017,341

(22) Filed: Jan. 22, 2008

(51) Int. Cl. G08B 21/18; G05B 19/40

(52) U.S. Cl. 340/648; 318/685

(57) ABSTRACT

A method for monitoring a step motor is provided, wherein the step motor rotates from a start position to an end position and then back to the start position repeatedly. The monitoring method includes: detecting a status signal of the step motor and a command signal received by the step motor in real time; recording a variation of the difference between the command signal and the status signal vs. time as an error data; and determining whether the step motor is starting from the start position, in action, reaching the end position, or returning to the start position according to the status signal and the command signal. If it is determined that the step motor is in action, the error data is recorded as a tracking error, and whether an alarm is issued is determined according to the tracking error.

### BACKGROUND OF THE INVENTION

1. Field of the Invention

The present invention generally relates to a system and a method for monitoring a step motor, in particular, to a system and a method for monitoring a step motor which performs a repetitive action.

2. Description of Related Art

The movement of a step motor is precisely controlled by intermittent electricity produced by transferring magnetic poles. Open-loop control is usually adopted by step motors. However, whether a step motor has lost step cannot be determined because there is no feedback mechanism in the step motor. Besides, only an end point error can be detected even though an encoder may be disposed in a step motor for controlling the movement of the step motor precisely.

When shift is caused by abnormality in a step motor, the step motor and related transmission devices are usually replaced without finding out the cause of the problem in order to imminently restore the operation of the system and also to prevent further occurrence of such problem. Accordingly, system cost is increased.

### SUMMARY OF THE INVENTION

Accordingly, the present invention is directed to a system and a method for monitoring a step motor, wherein an error between the physical action of the step motor and a command received by the step motor and/or a start point error when the step motor returns to a start position can be dynamically detected when the step motor rotates from the start position to an end position and then back to the start position. A working status (for example, the aging status) of the step motor and/or whether a transmission device or detection device coupled to the step motor is to be adjusted, calibrated, or replaced (for example, the aging status of an optical detector like a sensor used for detecting whether the step motor is back to the start position) can be determined according to foregoing errors.

The present invention provides a step motor monitoring system, wherein the step motor is driven by a driving unit, and the driving unit outputs a command signal and drives the step motor to rotate from a start position to an end position and then back to the start position repeatedly. The step motor monitoring system includes an encoder, a judgement unit, and a notification unit. The encoder mechanically coupled to the step motor detects the status of the step motor and outputs a status signal. The judgement unit receives the command signal from the driving unit and the status signal from the encoder in real time and records a variation of the difference between the command signal and the status signal vs. time as an error data, and the judgement unit determines whether the step motor is starting from the start position, in action, reaching the end position, or returning to the start position according to the command signal and the status signal. If the judgement unit determines that the step motor is in action, the judgement unit records the data as a tracking error and determines whether an alarm is to be issued according to the tracking error. The notification unit is coupled to the judgement unit and performs a notification function when the judgement unit determines that the alarm is to be issued.

The present invention further provides a step motor monitoring method, wherein the step motor rotates from a start position to an end position and then back to the start position repeatedly. The step motor monitoring method includes: detecting a status signal of the step motor and a command signal received by the step motor in real time; recording a variation of the difference between the command signal and the status signal vs. time as an error data; and determining whether the step motor is starting from the start position, in action, reaching the end position, or returning to the start position according to the status signal and the command signal. If it is determined that the step motor is in action, the error data is recorded as a tracking error, and whether an alarm is issued is determined according to the tracking error.

In the step motor monitoring method described above, if it is determined that the step motor is returning to the start position, the error data is recorded as a start point error, and whether the step motor has reached an aged status and/or whether a transmission or detection device coupled to the step motor is to be adjusted, calibrated, or replaced is determined according to the error data.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block diagram of a step motor monitoring system according to a first embodiment of the present invention.

FIG. 2 is a graph of a command signal and a status signal vs. time according to the first embodiment of the present invention, wherein the status signal is real time detected (received) by a judgement unit.

FIG. 3 is a graph of the variation of the difference between the command signal and the status signal vs. time wherein the command signal and the status signal are in FIG. 2.

FIG. 4 is a flowchart of a step motor monitoring method according to the first embodiment of the present invention.

FIG. 5 illustrates a variation of the step motor monitoring method in FIG. 4.

FIG. 6 is a block diagram of a step motor monitoring system according to a second embodiment of the present invention.

FIG. 7 is a flowchart of a step motor monitoring method according to the second embodiment of the present invention.

FIG. 8 is a graph of a command signal and a status signal vs. time by using the step motor monitoring method in FIG. 7.

FIG. 9 is another graph of the command signal and the status signal vs. time by using the step motor monitoring method in FIG. 7.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

### First Embodiment

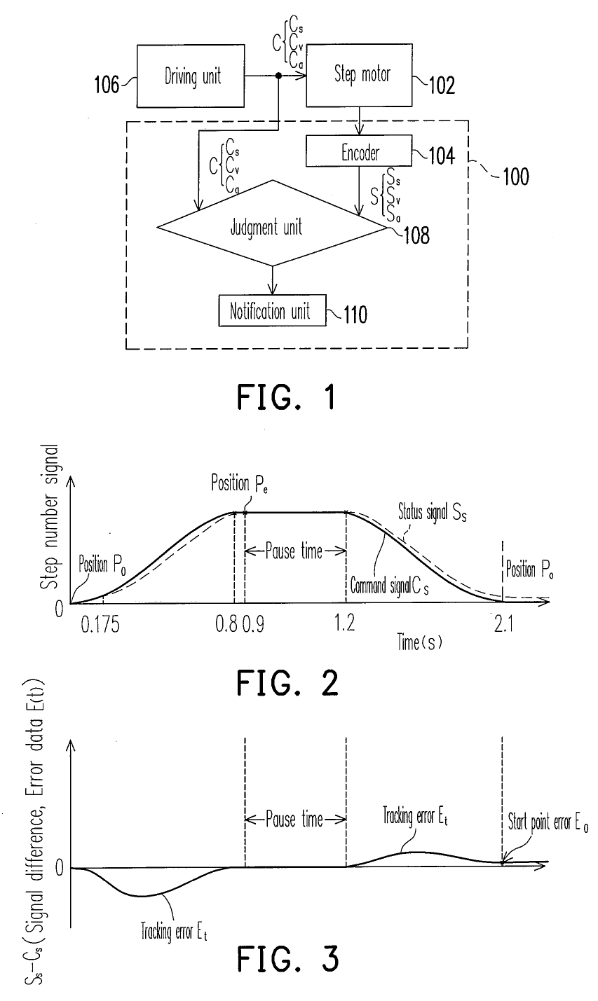

FIG. 1 is a block diagram of a step motor monitoring system according to the first embodiment of the present invention, and FIG. 2 is a graph of a command signal received from a driving unit and a status signal received from an encoder by a judgement unit in real time in the step motor monitoring system, wherein the signals are step number signals in FIG. 2 as examples.

According to the present invention, the step motor monitoring system 100 is suitable for monitoring a step motor 102 which performs a repetitive action.

The step motor 102 is driven by a driving unit 106. The driving unit 106 outputs a command signal C and drives the step motor 102 to rotate. The command signal C may include at least one of a command step number Cs, a command speed Cv, and a command acceleration Ca. The driving unit 106 includes an analog-to-digital input/output (ADIO) unit for converting an analog command into a digital command to be served as the command signal C.

The step motor 102 may rotate from a start position Po to an end position Pe and then back to the start position Po (as shown in FIG. 2) repeatedly. The step motor 102 may pause one or more times when it rotates from the start position Po to the end position Pe. Besides, the step motor 102 may pause between the repeated actions.

Such repetitive actions exist in various fabrication processes or movements driven by step motors. For example, a mechanical arm like a robot (not shown) driven by the step motor 102 performs a repetitive action as described below. However, the following example is only used for describing a repetitive action but not for limiting the pattern of the repetitive action or the purpose of the step motor in the present invention. The step motor may drive the mechanical arm to move horizontally, vertically, or randomly through appropriate mechanical configuration.

For example, the step motor 102 drives the mechanical arm to move from an original point (start position) to a wafer loading position to take in a wafer and move the wafer to a particular stage, and then the step motor 102 retracts the mechanical arm back to the original point. Once the processing of the wafer is completed at foregoing stage, the step motor 102 drives the mechanical arm to move from the original point to the stage to take out the processed wafer and move the wafer to a next stage, and then the step motor 102 drives the mechanical arm back to the original point. As described above, the step motor 102 performs a repetitive action.

The step motor monitoring system 100 includes an encoder 104, a judgement unit 108, and a notification unit 110.

The encoder 104 is mechanically coupled to the step motor 102. The encoder 104 converts the physical rotation of the step motor 102 into a corresponding digital signal and outputs a status signal S. Therefore, the status of the step motor 102 can be detected. Here the status signal S includes the step number Ss of the step motor; instead, the status signal S may also include at least one of the speed Sv and the acceleration Sa of the step motor.

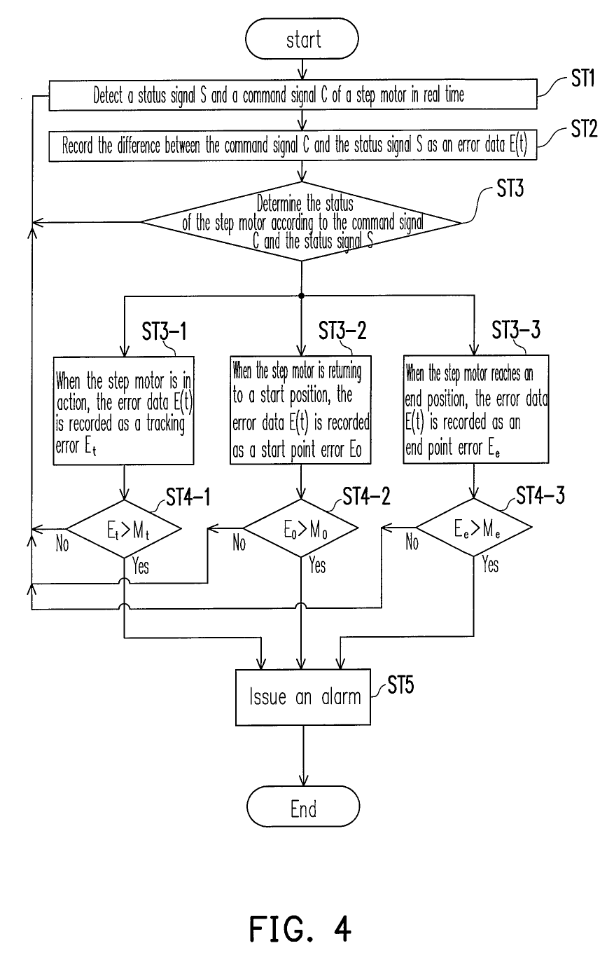

FIG. 3 is a graph of the difference between the command signal and the status signal vs. time (referred as an error data E(t)), and FIG. 4 is a flowchart of a monitoring method performed by a judgment unit according to the first embodiment of the present invention.

The judgement unit 108 receives the command signal C from the driving unit 106 and the status signal S from the encoder 104 in real time (step ST1) and records the difference between the command signal C and the status signal S vs. time (as shown in FIG. 3) as the error data E(t) (step ST2).

The judgement unit 108 further determines whether the step motor 102 is starting from the start position Po, in action, reaching the end position Pe, or returning to the start position Po according to the command signal C and the status signal S (step ST3).

The status of the step motor 102 may be determined according to the movement, the stop time point, and the direction of the movement during the entire action of the step motor 102, and foregoing information can be obtained from the graph of various signals (status signal and command signal) vs. time (as shown in FIG. 2). FIG. 2 is a graph of a step number signal detected in real time vs. time, wherein the real line is a curve of the command step number Cs output by the driving unit 106 vs. time, and the dotted line is a curve of the step number Ss of the step motor 102 vs. time.

Referring to FIG. 2, at about 0.175 second, the step motor 102 starts to produce tracking effect, which means the step motor 102 tries to reach the received command step number. However, there is still a difference between the step number of the step motor 102 and the command step number. The tracking effect ends at about 0.8 second. The step motor 102 is in action during foregoing period, and the error during this period is referred as a tracking error Et (referring to FIG. 3).

Thereafter, the step motor 102 pauses at about 0.9 second and stays there until about 1.2 second. After that, the step motor 102 starts to rotate reversely. During the pausing period before the step motor 102 starts to rotate reversely (i.e. the period between 0.9 second and 1.2 second), the step motor 102 is in such a status that it is reaching the end position Pe, and the error during this period is referred as an end point error Ee.

The step motor 102 starts to produce tracking effect again at 1.2 second and which ends at about 2.1 second when a response indicating that the step motor 102 has returned to the start position Po is received from a detector like a sensor (not shown). The error during the period between 1.2 second and 2.1 second is also referred as a tracking error Et. The error at 2.1 second is referred as a start point error Eo, namely, the error when the step motor 102 returns to the start position Po. The start point error Eo will be further described below.

The status (for example, the position, speed, and acceleration thereof) of the step motor 102 is obtained according to the output (i.e. the status signal) of the encoder 104 once the step motor 102 rotates away from the start position Po. The position of the step motor 102 can be obtained any time from the graph of the step number of the step motor 102 vs. time. Whether the step motor 102 is back to the start position Po is determined according to the output of the detector (not shown).

For example, when the step motor 102 reaches the end position Pe at 1000 steps and then receives a command step number from the driving unit 106 to return to the start position Po, ideally, the step motor 102 should rotates −1000 steps to return to the start position (point zero). However, whether the step motor 102 is back to the start position Po is determined by a detector (for example, an optical detector or a contact detector). Thus, when the step motor 102 is about to reach the start position Po, the step motor 102 keeps rotating until the detector indicates that the step motor 102 has reached the start position Po, and this point is used as the start position of the next action. At this point, the step motor 102 may not return to the original start position Po if the response of the detector is slowed down or advanced by the decay of light, an abnormality of the detector, or the aging of a transmission device coupled to the step motor, and accordingly the start position of the next action is also changed. The shift of the start position here is referred as a start point error Eo.

When the judgement unit 108 determines that the step motor 102 is in action, if foregoing tracking effect during the period between 0.175 second and 0.8 second (as shown in FIG. 2) is produced, the error data E(t) is recorded as the tracking error Et (step ST3-1) and whether an alarm is to be issued is determined according to the tracking error Et (step ST4-1). If the absolute value of the tracking error Et is greater than or equal to a predetermined value Mt, namely, the maximum value of the tracking error acceptable to the system is reached, the judgement unit 108 determines that an alarm is to be issued (step ST5).

When the judgement unit 108 determines that the step motor 102 is returning to the start position Po, if foregoing situation at 2.1 second (as shown in FIG. 2) takes place, the error data E(t) here is recorded as a start point error Eo (step ST3-2) and whether an alarm is to be issued is determined according to the start point error Eo (step ST4-2). If the absolute value of the start point error Eo is greater than or equal to a predetermined value Mo, namely, the maximum value of the start point error acceptable to the system is reached, the judgement unit 108 determines that an alarm is to be issued (step ST5).

When the judgement unit 108 determines that the step motor 102 is reaching the end position Pe, the error data E(t) here is recorded as an end point error Ee (step ST3-3), and whether an alarm is to be issued is determined according to the end point error Ee (step ST4-3).

If the absolute value of the end point error Ee is greater than or equal to a predetermined value Me, namely, the maximum value of the end point error acceptable to the system is reached, the judgement unit 108 determines that an alarm is to be issued (step ST5).

The procedure returns to step ST1 if the step motor 102 is not in action, reaching the end position, or returning to the start position.

The predetermined values may be manually-set error tolerances or error tolerances obtained from the error data E(t) through statistic calculations. According to an experiment of the present invention, if precise position change is required, the error tolerances of the step number can be set to: Mo=40, Mt=100, and Me=40, and if position change of normal precision is required, the error tolerances of the step number can be set to: Mo=160, Mt=200, and Me=40.

Besides being set manually, the error tolerances may also be set through statistic calculations. For example, the average values of the errors Et and Eo in the monitoring system can be calculated according to the history of the error data E(t). If there are both positive and negative values, the average values can be calculated based on the absolute values or square values of the errors, such as (|Et|)average and (Et²)average. After that, the average values are multiplied by appropriate weights and the products are used as the error tolerances. In other words, the error tolerances can be calculated according to the history of the error data besides being set manually.

The notification unit 110 may be a buzzer and which is coupled to the judgement unit 108. The notification unit 110 performs a notification function when the judgement unit 108 determines that an alarm is to be issued. Even though here a buzzer is used as an example of the notification unit 110 and accordingly a sound alarm is issued, the alarm may also be issued in a form of flash light, text, or a combination of sound, light, and text.

A capacitor filter (not shown) may be further disposed between the judgement unit 108 and the encoder 104 for reducing crosstalk interference.

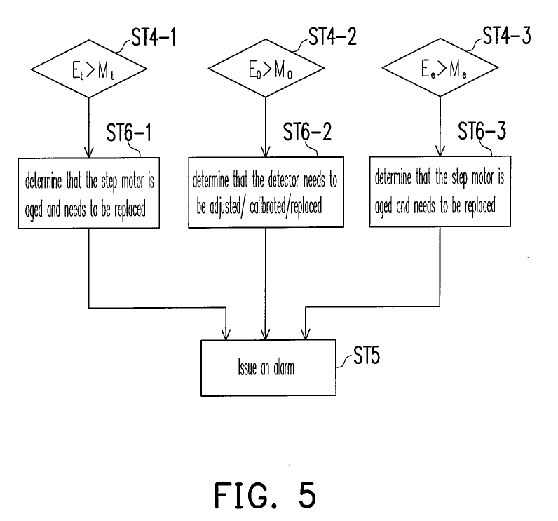

FIG. 5 is a flowchart illustrating how the judgement unit further determines the cause of an abnormality according to the error data.

The judgement unit 108 can further determine the cause of the abnormality according to the error data E(t) between steps ST4-1˜ST4-3 and step ST5.

The working status of the step motor 102 can be determined according to the error data E(t) (for example, the tracking error Et and the end point error Ee), and the working status of the detector (for detecting whether the step motor is back to the start position) can be determined according to the start point error Eo. For example, when the tracking error Et reaches the error tolerance Mt or the end point error Ee reaches the error tolerance Me so that an alarm is issued, it is determined that the step motor 102 has reached an aged status and needs to be replaced, and when the start point error Eo reaches the error tolerance Mo so that an alarm is issued, it is determined that a transmission device (not shown) or the detector coupled to the step motor needs to be adjusted, calibrated, or replaced (for example, needs to replace lubricating oil or detecting signal line . . . etc).

In the present embodiment, the alarm is issued according to the errors Et, Eo, and Ee. However, the alarm may also be issued according to only the tracking error Et. Besides, the alarm may be issued according to at least one of foregoing three errors.

The tracking error Et provided by the present invention is a dynamic error, and which is produced during the action of the step motor. The dynamic error is increased when the load of the step motor is too large or the step motor is too aged to keep up with the command signal output by the driving unit. In this case, the end point error or start point error will be produced if the step motor keeps performing its operation. Thereby, the step motor can be determined to be aged based on only the tracking error Et when the errors Eo and Ee are still within tolerated ranges.

In the present invention, the aging status of a step motor can be determined by simply monitoring a tracking error so that the step motor can be replaced at right time. Besides, the working status of a transmission device or a detector coupled to the step motor can be determined by monitoring a start point error so that the transmission device or the detector can be adjusted, calibrated, or replaced at right time. Thus, it is not necessary to replace all the step motor and the other related components, such as the transmission device or the detector, when the step motor has lost step. Thereby, the overhaul and repairing cost of the equipment is reduced and an maintenance schedule can be automatically established.

### Second Embodiment

In a monitoring system provided by the present invention, a command signal output by a driving unit can be modified according to the actual situation besides detecting the working status of a step motor according to the detected signals.

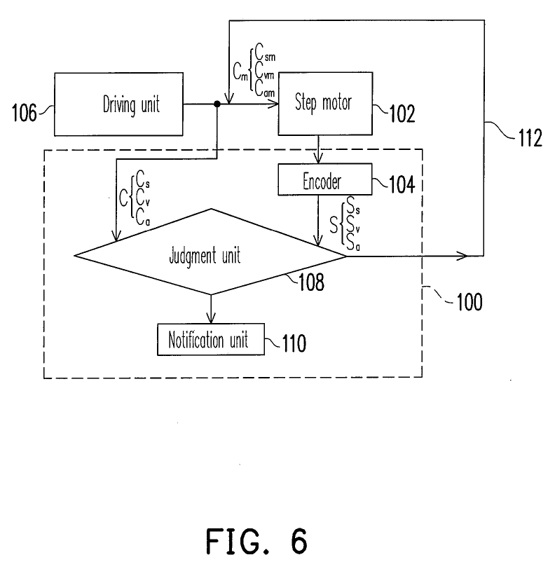

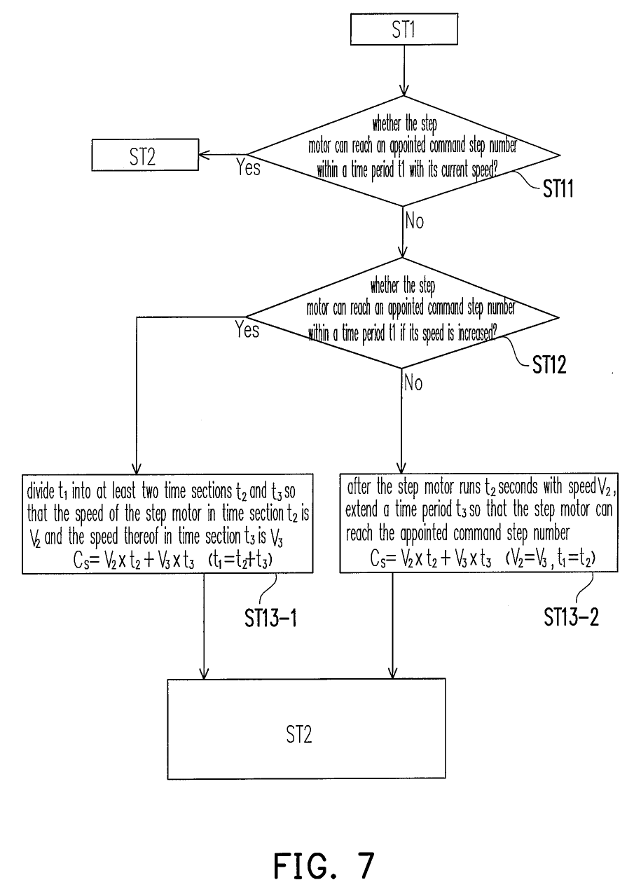

FIG. 6 is a block diagram of a step motor monitoring system according to the second embodiment of the present invention, and FIG. 7 is a flowchart of a step motor monitoring method according to the second embodiment of the present invention.

Compared to the first embodiment, a feedback circuit 112 is further disposed in the second embodiment for transmitting a modified command signal Cm to the step motor 102.

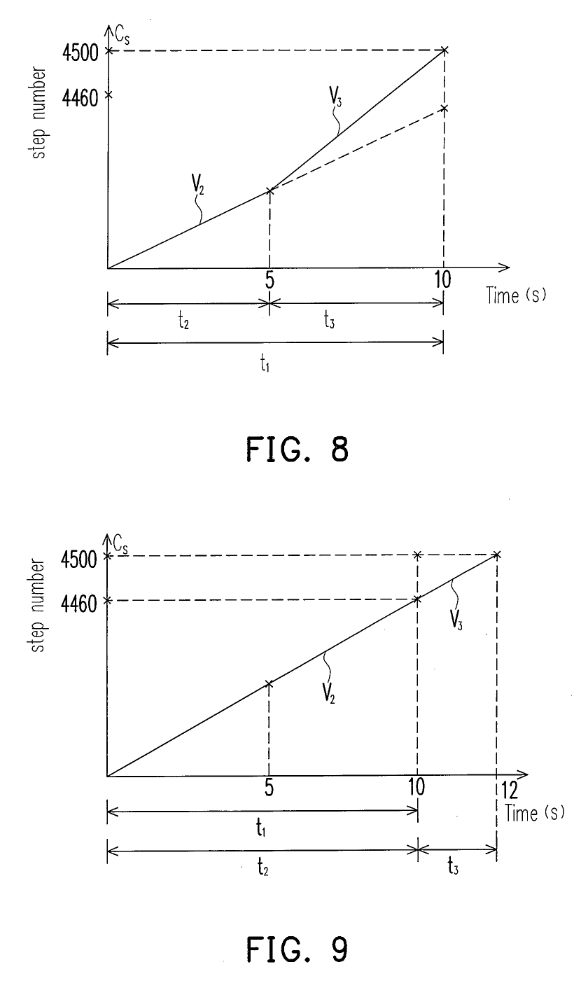

FIG. 8 is a graph of signal vs. time, wherein the judgement unit modifies the command signal so that the step motor can reach the original command step number within a time period.

For example, the driving unit 106 requests the step motor 102 to reach an appointed command step number Cs within a time period t1 (for example, to run 4600 steps within 10 seconds). The judgement unit determines whether the step motor 102 can reach the command step number Cs within the time period t1 with its current speed V2 (step ST11). If the judgement unit 108 determines that the step motor 102 cannot reach the command step number 4600 (Cs) within the time period t1 with its current speed V2, for example, the step motor 102 can only run 4460 steps within the time period t1, the judgement unit 108 further determines whether the step motor 102 can reach the appointed command step number if the speed thereof is increased (step ST12). If the judgement unit 108 determines that the step motor 102 can reach the appointed command step number if the speed thereof is increased, the judgement unit 108 terminates the command signal Cs of the driving unit 106 and divides the time period t1 into at least two time sections t2 and t3, wherein the two time sections may not be equal. The judgement unit 108 provides a modified command signal Cm (for example, a higher command speed Cvm, which is V3 in the present embodiment) to the step motor 102 (step ST13-1), wherein m represents “modify”, so that the step motor 102 can reach the command step number Cs within the time period t1.

In the present embodiment, the time period of 10 seconds is divided into two time sections of 5 seconds. However, the time period may not be divided into equal time sections, and it is within the scope of the present invention as long as the step motor 102 can reach the command step number 4600 (Cs) in at least two steps (two steps in FIG. 8). Following condition is to be met in the present embodiment:

Cs=V2×t2+V3×t3, wherein t1=t2+t3.

FIG. 9 is another graph of signal vs. time, wherein the judgement unit modifies the command signal so that the step motor can prolong the time period so as to reach the original command step number.

For example, the driving unit 106 requests the step motor 102 to reach an appointed command step number Cs within a time period t1 (for example, to run 4600 within 10 seconds). The judgement unit determines whether the step motor 102 can reach the command step number Cs within the time period t1 with its current speed V2 (step ST11). If the judgement unit 108 determines that the step motor 102 cannot reach the command step number 4600 (Cs) within the time period t1 with its current speed V2, for example, the step motor 102 can only run 4460 steps within the time period t1, and the judgement unit 108 determines that the step motor 102 cannot reach the command step number even the speed thereof is increased (step ST12), the judgement unit 108 terminates the command signal of the driving unit 106 and allows the step motor 102 to finish the command step number 4600 (Cs) within an extended time period (for example, a time period t3) (step ST13-2). Following condition is to be met in the present embodiment:

Cs=V2×t2+V3×t3, wherein t1=t2, and V2=V3.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A step motor monitoring system, for monitoring a step motor, wherein the step motor is driven by a driving unit, and the driving unit outputs a command signal and drives the step motor to rotate from a start position to an end position and then back to the start position repeatedly, the step motor monitoring system comprising:
an encoder, mechanically coupled to the step motor, the encoder detecting a status of the step motor and outputting a status signal;
a judgment unit, for real time receiving the command signal from the driving unit and the status signal from the encoder, recording a variation of a difference between the command signal and the status signal vs. time as an error data, and determining whether the step motor is starting from the start position, in action, reaching the end position, or returning to the start position according to the command signal and the status signal, wherein if the judgment unit determines that the step motor is in action, the judgment unit records the error data as a tracking error and determines whether an alarm is to be issued according to the tracking error;
a notification unit, coupled to the judgment unit, the notification unit performing a notification function when the judgment unit determines that the alarm is to be issued.

2. The step motor monitoring system according to claim 1, wherein when the judgment unit determines that the step motor is returning to the start position, the judgment unit records the error data as a start point error and determines whether the alarm is to be issued according to the start point error.

3. The step motor monitoring system according to claim 1, wherein the status signal comprises at least one of a step number of the step motor, a speed of the step motor, and an acceleration of the step motor, and the command signal comprises at least one of a command step number, a command speed, and a command acceleration.

4. The step motor monitoring system according to claim 1, wherein the judgment unit determines that the alarm is to be issued when a relationship between the command signal and the status signal meets:
(|the status signal−the command signal|/the command signal)>a predetermined value.

5. The step motor monitoring system according to claim 1 further comprising a feedback circuit, wherein the judgment unit outputs a modified command signal to the step motor via the feedback circuit so as to allow the step motor to reach a command step number corresponding to the command signal in at least two steps.

6. The step motor monitoring system according to claim 5, wherein the at least two steps comprise: when the command signal is to make the step motor reach the command step number Sc after a time period t1, dividing the time period t1 into at least two time sections t2 and t3, wherein a speed of the step motor is V2 during the time section t2, and a speed of the step motor is V3 during the time section t3, and adjusting the speeds V2 and V3 and the time sections t2 and t3 to meet:
Sc=V2×t2+V3×t3, wherein t1=t2+t3.

7. The step motor monitoring system according to claim 5, wherein the at least two steps comprise: when the command signal is to make the step motor reach the command step number Sc after a time period t1, dividing a period longer than the time period t1 into at least two time sections t2 and t3, wherein a speed of the step motor is V2 during the time section t2, and a speed of the step motor is V3 during the time section t3, and adjusting the speed V2 and the time section t3 to meet:
Sc=V2×t2+V3×t3, wherein t1=t2, and V2=V3.

8. The step motor monitoring system according to claim 1, wherein the notification unit comprises a buzzer.

9. The step motor monitoring system according to claim 1, wherein the driving unit comprises an analog-to-digital input/output (ADIO) unit for converting an analog command into a digital command to be served as the command signal.

10. The step motor monitoring system according to claim 1 further comprising a capacitor filter coupled between the notification unit and the encoder.

11. A step motor monitoring method, for monitoring a step motor, wherein the step motor rotates from a start position to an end position and then back to the start position repeatedly, the step motor monitoring method comprising:
real time detecting a status signal of the step motor and a command signal received by the step motor;
recording a variation of the difference between the command signal and the status signal vs. time as an error data, and determining whether the step motor is starting from the start position, in action, reaching the end position, or returning to the start position according to the command signal and the status signal, wherein if it is determined that the step motor is in action, the error data is recorded as a tracking error and whether an alarm is to be issued is determined according to the tracking error.

12. The step motor monitoring method according to claim 11, wherein the command signal comprises at least one of a command step number, a command speed, and a command acceleration, and the status signal comprises at least one of a step number of the step motor, a speed of the step motor, and an acceleration of the step motor.

13. The step motor monitoring method according to claim 11 further comprising determining a working status of the step motor according to the error data.

14. The step motor monitoring method according to claim 13, wherein determining the working status of the step motor comprises: determining that the step motor has reached an aged status when the alarm is issued according to the tracking error.

15. The step motor monitoring method according to claim 11, wherein it is determined that the alarm is to be issued when a relationship between the command signal and the status signal meets:
(|the status signal−the command signal|/the command signal)>a predetermined value.

16. The step motor monitoring method according to claim 15, wherein the predetermined value is a manually-set error tolerance or an error tolerance obtained from the error data through statistic calculations.

17. The step motor monitoring method according to claim 11 further comprising allowing the step motor to reach a command step number corresponding to the command signal in at least two steps after the command signal is received.

18. The step motor monitoring method according to claim 17, wherein the at least two steps comprise: when the command signal is to make the step motor reach the command step number Sc after a time period t1, dividing the time period t1 into at least two time sections t2 and t3, wherein a speed of the step motor is V2 during the time section t2, and a speed of the step motor is V3 during the time section t3, and adjusting the speeds V2 and V3 and the time sections t2 and t3 to meet:
Sc=V2×t2+V3×t3, wherein t1=t2+t3.

19. The step motor monitoring method according to claim 17, wherein the at least two steps comprise: when the command signal is to make the step motor to reach the command step number Sc after a time period t1, dividing a period longer than the time period t1 into at least two time sections t2 and t3, wherein a speed of the step motor is V2 during the time section t2, and a speed of the step motor is V3 during the time section t3, and adjusting the speed V2 and the time section t3 to meet:
Sc=V2×t2+V3×t3, wherein t1=t2, and V2=V3.

20. The step motor monitoring method according to claim 11, wherein when it is determined that the step motor is returning to the start position, the error data is recorded as a start point error, and whether the alarm is to be issued is determined according to the start point error.

21. The step motor monitoring method according to claim 20 further comprising determining a working status of the step motor according to the error data.

22. The step motor monitoring method according to claim 21, wherein determining the working status of the step motor comprises: determining whether a transmission device or a detection device coupled to the step motor is to be adjusted, calibrated, or replaced when the alarm is issued according to the start point error.

23. A step motor monitoring method, for monitoring a step motor, wherein the step motor rotates from a start position to an end position and then back to the start position repeatedly, the step motor monitoring method comprising:
real time detecting a status signal of the step motor;
real time detecting a command signal received by the step motor;
recording a variation of the difference between the command signal and the status signal vs. time as an error data, and determining whether the step motor is starting from the start position, in action, reaching the end position, or returning to the start position according to the command signal and the status signal, wherein if it is determined that the step motor is in action, the error data is recorded as a tracking error, and if it is determined that the step motor is returning to the start position, the error data is recorded as a start point error;
determining whether the step motor has reached an aged status and/or whether a transmission device or a detection device coupled to the step motor is to be adjusted, calibrate, or replaced according to the error data.
